(19) United States
(12) Patent Application Publication
(10) Pub. No.: US 2018/0128391 A1
(43) Pub. Date: May 10, 2018

(54) NIPPLE

(71) Applicant: CEJN AB, Skövde (SE)

(72) Inventors: Jörgen EKSTRÖM, Skövde (SE); Roy ERIKSSON, Skövde (SE); Frank ROTTGARDT, Skövde (SE)

(73) Assignee: CEJN AB, Skövde (SE)

(21) Appl. No.: 15/564,370

(22) PCT Filed: Apr. 5, 2016
(86) PCT No.: PCT/EP2016/057418

§ 371 Date: Oct. 4, 2017

(30) Foreign Application Priority Data
Apr. 7, 2015 (GB) 1505894.4

(51) Int. Cl. F16K 17/04; F16K 15/02; F16L 37/35; F16L 37/56; F16L 39/04

(52) U.S. Cl. CPC F16K 17/0473; F16K 15/026; B25B 21/00; F16L 37/56; F16L 39/04; F16L 37/35

(57) ABSTRACT

A nipple for a coaxial coupling is disclosed. The nipple comprises a housing (40), and a nipple tube (30) arranged in the housing (40). The nipple comprises a first passage (42) between the housing (40) and the nipple tube (30), and the nipple tube (30) comprising a second passage (32) within the nipple tube (30). A relief valve (20) is slideably arranged in the nipple tube (30). The nipple comprises sealing means (24, 26) for sealing between the nipple tube (30) and the relief valve (20). The nipple tube (30) further comprises a relief passage (34), the relief passage (34) forming a fluid passage between the first passage (42) and the second passage (32). The relief passage (34) being arranged so that the sealing means (24, 26) seals the relief passage (34) when the nipple is fully coupled.

### TECHNICAL FIELD

The present disclosure relates to a nipple. More particularly, the present disclosure relates to a nipple for a coaxial coupling. More particularly, the present disclosure relates to a nipple for a coaxial coupling and a swivel.

### BACKGROUND

Many hydraulic tools driven by hydraulic fluid require couplings. Such couplings supply hydraulic fluid to a hydraulic tool and return the hydraulic fluid from the tool to a fluid supply. A drawback with couplings, especially coaxial couplings, is that, if a cold hydraulic tool with a nipple (the male part, not coupled together with the coupling, the female part) is left in the sun, then the hydraulic oil in the nipple and the tool expands and the enclosed pressure increases. This pressure can be up to a few hundred bars (a few 10 MPa), which makes coupling together by hand force impossible without the use of special tools, etc. to discharge the pressure into the open air. This adversely affects the use and the operation of the tool and its coupling.

A further drawback with known coaxial couplings is that, since the coupling (the female part) is pressurized, when a pressurized supply fluid is connected to the female part, a quick-fit coupling can not be connected without manually applying a large force. This can result in that a connection with the tool can not be made and the tool can therefore not be used.

A further technical problem is that couplings for a hydraulic tool do not allow much movement or freedom of the hydraulic supply hoses. When the hoses are coupled to the hydraulic tool, then the hoses can prevent the hydraulic tool from reaching or operating at the necessary location. Further problems arise when the hoses are under pressure of the hydraulic fluid and can not be moved easily or at all. A coupling that allows the hoses to be moved in relation to the hydraulic tool is desirable.

A further technical problem is that any coupling part must also fit and work together with already existing tools and existing hose kits. It is desirable that parts of the coupling are not expensive to produce. It is further a technical problem to avoid cumbersome arrangement and/or arrangements that are expensive to manufacture.

### SUMMARY OF THE INVENTION

It is an object of the present invention to provide a nipple for a coaxial coupling. This object can be achieved by the features as defined by the independent claims. Further enhancements are characterized by the dependent claims. This object can also be achieved by a coupling comprising the nipple and a swivel.

According to one embodiment, a nipple for a coaxial coupling is disclosed. The nipple comprises a housing (40) and a nipple tube (30). The nipple tube (30) is arranged in the housing (40). The nipple comprises a first passage (42) between the housing (40) and the nipple tube (30), and the nipple tube (30) comprising a second passage (32) within the nipple tube (30). The nipple further comprises a valve (20) slideably arranged in the nipple tube (30), and sealing means (24, 26) for sealing between the nipple tube (30) and the valve (20). The nipple tube (30) further comprises a relief passage (34), the relief passage (34) forming a fluid passage between the first passage (42) and the second passage (32), the relief passage (34) being arranged so that the sealing means (24, 26) seals the relief passage (34) when the nipple is fully coupled. Preferably the valve (20) is a relief valve (20).

According to one embodiment, a coupling comprises the nipple mentioned above and a swivel. The swivel comprising a swivel part (300), a first part (100), and a second part (200). The swivel part (300) comprises a rotational axis (350) and a swivel part first channel (320) inside the swivel part for a supply fluid. The first part (100) comprises a first opening (110) for the swivel part, a first part first channel (120) for the supply fluid, and a first part second channel (130) for a return fluid. The first part (100) being configured for receiving the supply fluid and for returning the return fluid. The second part (200) comprises a second opening (210) for the swivel part (300), a second part first channel (220) for the supply fluid, and a second part second channel (230) for the return fluid. The second part (200) being configured for receiving a rotatable coupling (400) for the nipple (10). The swivel part (300) arranging the first part (100) and the second part (200) rotatably engaged with each other, the first opening (110) holding substantially half the swivel part (300) and the second opening (210) holding substantially the other half of the swivel part (300).

According to one embodiment, the swivel comprises a swivel part second channel (330) for the return fluid. The swivel part second channel (330) being around the swivel part (300) and inside one or both of the first part (100) and second part (200). The swivel part channel (320) channels the supply fluid inside the swivel part (300) and the swivel part second channel (330) channels the return fluid outside the swivel part (300). In this way the flow of the fluid in the swivel part (300) is coaxial, while the flow of fluid in the first part (100) and the second part (200) is not coaxial. Preferably a rotation axis (250) of the second part (200), for the rotatable coupling (400), is substantially perpendicular to the rotation axis (350) of the swivel part (300).

According to at least one embodiment, the coupling is for a high pressure supply fluid. The coupling may comprise an adapter for twin hoses or a coaxial hose (not shown in the figures) for the supply and return fluids. The coupling may be configured for a supply fluid having a higher pressure than the return fluid by channelling the supply fluid through the swivel part first channel (320).

According to one embodiment, a tool comprises a nipple or a coupling according to any one of the embodiments disclosed herein. Preferably, the rotatable coupling is connectable with a nipple, the nipple being directly arranged in the tool.

According to at least one embodiment, pressure built up can be vented so that coupling can be made by hand force. Furthermore, according to at least one embodiment, a coupling that allows the hoses to be moved in relation to the hydraulic tool is provided. Embodiments of the coupling fit and work together with already existing tools, couplings, and hose kits. The parts of the coupling are not expensive to produce. At least one embodiment avoids cumbersome arrangement and/or arrangements that are expensive to manufacture.

At least one of the above embodiments provides one or more solutions to the problems and disadvantages with the background art. Other technical advantages of the present disclosure will be readily apparent to one skilled in the art from the following description and claims. Various embodiments of the present application obtain only a subset of the advantages set forth. No one advantage is critical to the embodiments. Any claimed embodiment may be technically combined with any other claimed embodiment(s).

### BRIEF DESCRIPTION OF THE DRAWINGS

The accompanying drawings illustrate presently exemplary embodiments of the disclosure and serve to explain, by way of example, the principles of the disclosure.

FIG. 1 is a diagrammatic illustration of a nipple according to an exemplary embodiment of the disclosure;

FIG. 2 is a diagrammatic illustration of a nipple according to an exemplary embodiment of the disclosure;

FIG. 3 is a diagrammatic illustration of a swivel according to an exemplary embodiment of the disclosure;

FIG. 4 is a diagrammatic illustration of a swivel according to an exemplary embodiment of the disclosure;

FIG. 5 is a diagrammatic illustration of a swivel according to an exemplary embodiment of the disclosure;

FIG. 6 is a diagrammatic illustration of a swivel according to an exemplary embodiment of the disclosure;

FIG. 7 is a diagrammatic illustration of a swivel according to an exemplary embodiment of the disclosure;

FIG. 8 is a diagrammatic illustration of a nipple according to an exemplary embodiment of the disclosure; and

FIG. 9 is a diagrammatic illustration of a nipple according to an exemplary embodiment of the disclosure.

### DETAILED DESCRIPTION

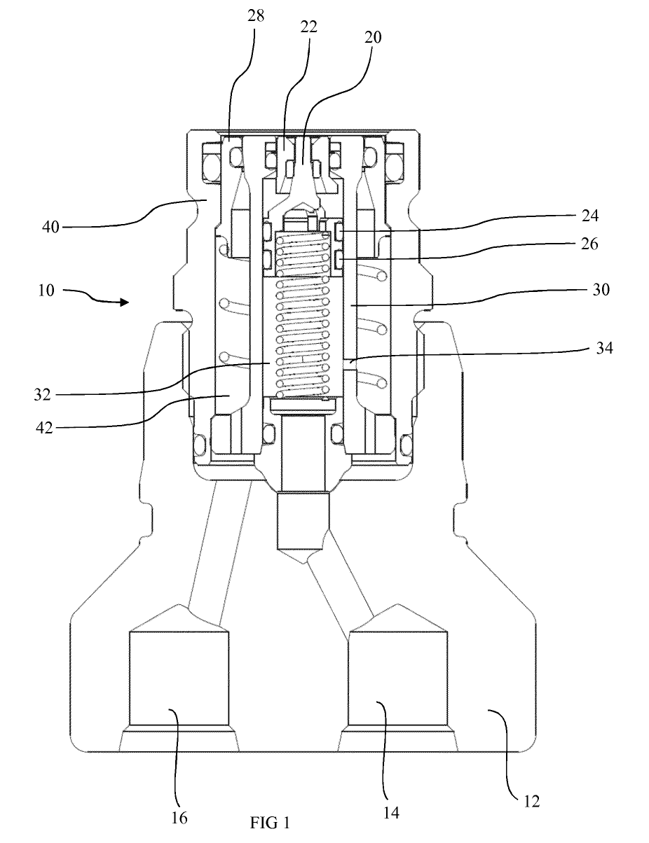

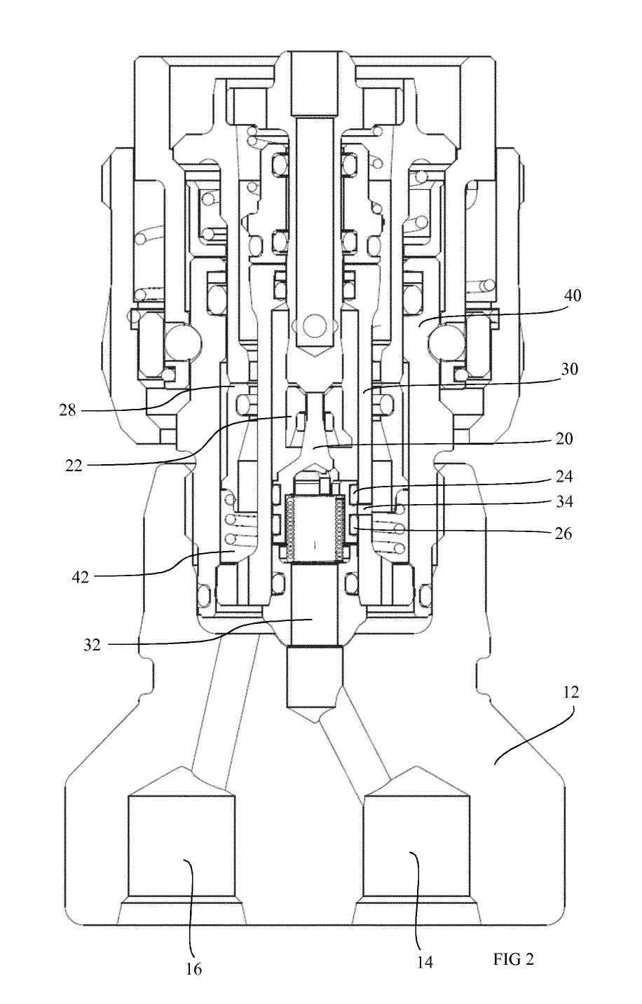

FIG. 1 shows a nipple according to one embodiment. This nipple is illustrated in an un-coupled state. In FIG. 1 fluid can flow via a second opening (16) of the tool (12), via a first passage (42), via a relief passage (34), via a second passage (32), via a first opening (14) of the tool (12). Hereby a built up pressure in different passages of the tool and the nipple can circulate and vent through relive valve (20) when connected. A technical effect hereof is that it becomes possible to connect, couple, the nipple by normal hand force. FIG. 2 shows the same nipple according to one embodiment, but here the nipple is illustrated in a coupled state. As later explained in more detail, in FIG. 2 the above mentioned flow is not possible because the relief passage (34) is sealed of by sealing means (24, 26).

FIG. 1 shows a nipple for a coaxial coupling according to one embodiment. The nipple comprises a housing (40), a nipple tube (30), and a valve (20). The valve (20) may be a relief valve (20).

The nipple tube (30) may be arranged in the housing (40). The nipple tube may be arranged centrally within the housing (40). Both the housing (40) and the nipple tube (30) may be cylindrical in shape. The nipple tube (30) has a smaller outer diameter than the inner diameter of the housing (40) and forms a first passage (42) between the housing (40) and the nipple tube (30). The nipple tube (30) comprising a second passage (32) within the nipple tube (30). The second passage (32) may be centrally within the nipple tube (30).

The valve (20) may be slideably arranged in the nipple tube (30). The valve (20) comprising sealing means (24, 26) for sealing against the nipple tube (30). The sealing means (24, 26) may for example be o-rings around the valve (20) sealing against the inner diameter of the nipple tube (30). The sealing means (24, 26) may be one or more sealing means.

The nipple tube (30) further comprises a relief passage (34). The relief passage (34) forms a fluid passage between the first passage (42) and the second passage (32). The relief passage (34) may be, for example, one or more holes through the nipple tube (30). The relief passage (34) being arranged so that the sealing means (24, 26) seals the relief passage (34) when the nipple is fully coupled. While the valve (20) is not in its final coupled position, then the relief passage (34) is not sealed and allows for fluid to pass between the first passage (42) and the second passage (32). However, when the nipple is fully engaged in the coupling, then the sealing means (24, 26) of valve (20) seals the relief passage (34) and no fluid can pass between the first passage (42) and the second passage (32) via the relief passage (34).

According to one embodiment, the valve (20) is a relief valve (20). According to one embodiment, the relief valve (20) is the relief valve for an inner valve (22) for the second passage (32), for the nipple tube (30). The relief valve (20) may be centrally arranged in the inner valve (22).

According to one embodiment, the valve (20) may be spring loaded for movement away from the relief passage (34). That is, the spring pushes the relief valve (20) and the inner valve (22) to seal at the end of the nipple tube (30). The spring is arranged within the nipple tube (30) and allows for fluid to pass through the spring, especially in its compressed state, as illustrated in FIG. 2.

According to one embodiment, the housing (40) and the nipple tube (30) both may have a generally cylindrical form. According to one embodiment, the nipple may further comprise an outer valve (28) for the first passage (42). The outer valve (28) may be generally cylindrical in shape. The outer valve (28) may be spring loaded towards the end of the nipple to seal the first passage (42). That is, the spring pushes the outer valve (28) to seal at the end between the nipple tube (30) and the housing (40).

According to one embodiment, the nipple is attached directly in a hydraulic tool (12). Preferably the hydraulic tool (12) is a torque wrench tool. Any built up pressure in the tool will be allowed to vent through the relief valve (20) via the relief passage (34) if necessary. When the relief valve (20) opens, then pressure built up in different parts of the tool (12) (and nipple) can circulate and vent through the relief valve (20). It does not matter if the pressure is built up within the first opening (14) or the second opening (16) of the tool (12) because of the relief passage (34). This allows the hydraulic tool to be coupled by hand force.

According to one embodiment, the nipple further comprises a plurality of the relief passages (34) between the first passage (42) and the second passage (32). The plurality of relief passages (34) may be arranged so that the sealing means (24, 26) seals the plurality of relief passages (34) when the nipple is fully coupled.

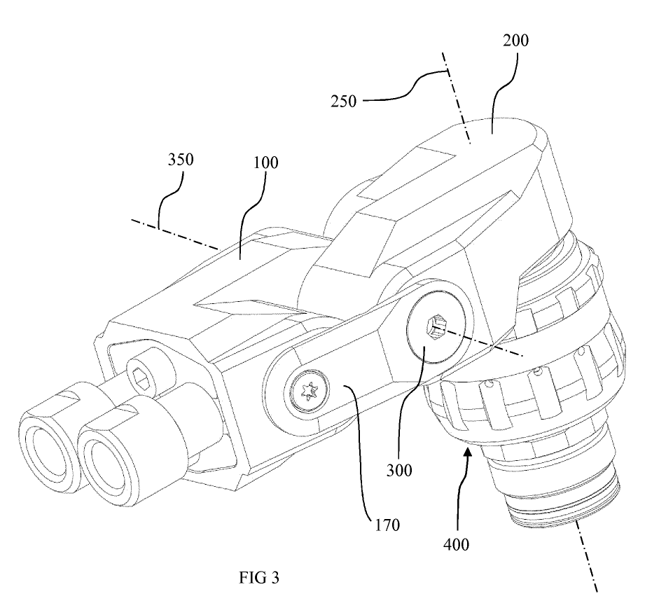

According to one embodiment, the nipple is part of a coupling comprising the nipple and a swivel and a rotatable coupling. FIG. 3 shows a coupling according to one embodiment with a swivel (100, 200, 300) and a rotatable coupling (400). The rotatable coupling (400) being connectable with the nipple according to any one of the embodiments described of the nipple. The swivel rotates about a rotation axis (350) and the rotatable coupling (400) rotates about a rotation axis (250). The two rotation axes may be perpendicular. The coupling allows in this way movement and freedom between hydraulic hoses and a hydraulic tool, i.e. the hoses will not be in the way for operating the tool. The hydraulic hoses may be connected to the swivel and the rotatable coupling may be connected to the tool. The rotatable coupling may be a coaxial coupling. The coupling may be for a supply fluid and a return fluid. The fluid may be a hydraulic fluid. The coupling may be used for connecting a hydraulic tool with a hydraulic fluid supply. Such hydraulic fluid may be supplied to the hydraulic tool and returned to the hydraulic fluid supply.

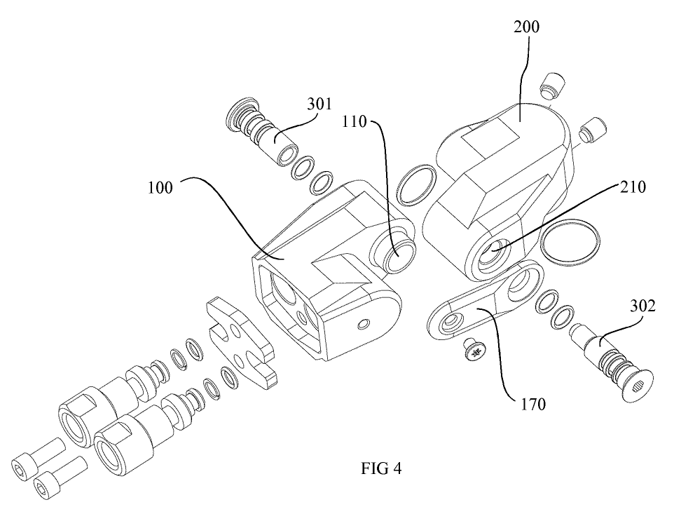

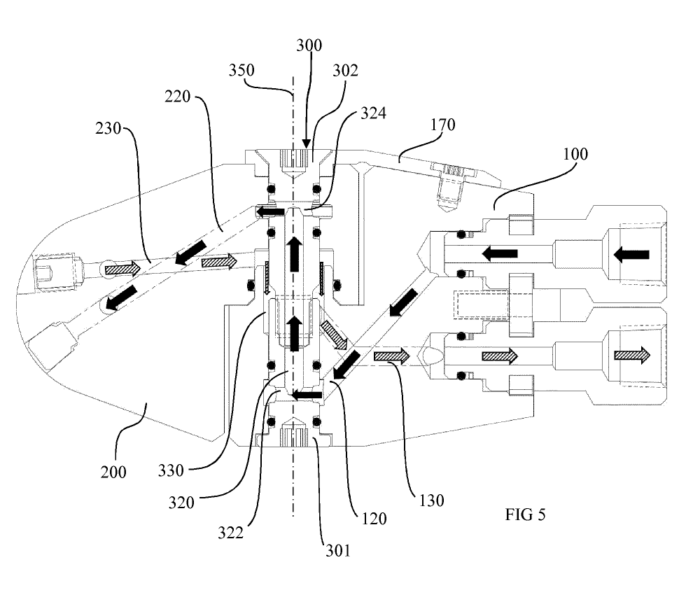

With reference to FIGS. 4 and 5, according to one embodiment, the coupling may comprise a swivel part (300). The swivel part (300) may comprise a rotational axis (350) and a swivel part first channel (320) inside the swivel part (300) for the supply fluid. The swivel part first channel (320) may be completely within the swivel part (300). The swivel part first channel (320) may be for the supply fluid, having a higher pressure than the return fluid. In this way leakage is effectively prevented, rotational movement of the swivel is made easier, and reduction of stress caused by the pressurised fluid is reduced.

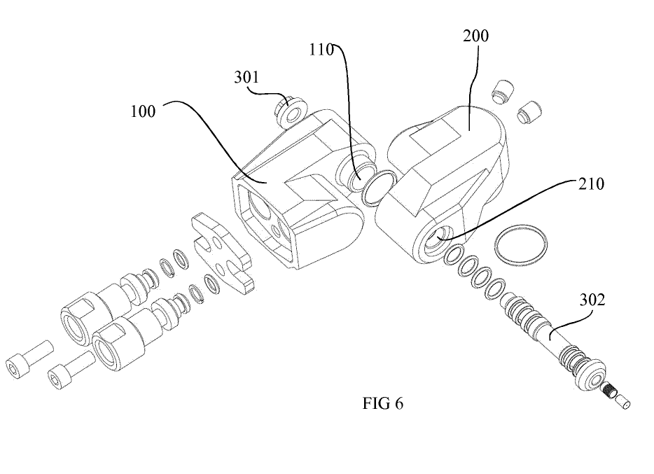

The coupling may comprise a first part (100) comprising a first opening (110) for the swivel part (300), a first part first channel (120) for the supply fluid, and a first part second channel (130) for the return fluid. The first part (100) may be configured to receive the supply fluid and to return the return fluid. This may be done by connecting hydraulic hoses from a supply to the first part (100). Two parallel adapters are illustrated as examples for this in FIGS. 3-7. These adapters may be able to rotate in relation to the first part (100). A coaxial coupling may be used instead for the first part (100) to connect to a supply fluid.

The coupling may comprise a second part (200) comprising a second opening (210) for the swivel part (300), a second part first channel (220) for the supply fluid, and a second part second channel (230) for the return fluid. The second part (200) may be configured to receive a rotatable coupling (400). The rotatable coupling (400) may be a coaxial coupling and connectable with a nipple in the hydraulic tool.

The coupling may be further configured such that the swivel part (300) arranges the first part (100) and the second part (200) rotatably relative to each other. In this way the two parts are held together. The swivel part (300) is connecting, holding, the first part (100) and the second part (200) rotatably relative to each other. The first opening (110) holding substantially half the swivel part (300) and the second opening (210) holding substantially the other half of the swivel part (300). The first opening (110) is so to say accommodating, taking up, about half the swivel part (300) and the second opening (210) is accommodating, taking up, about the other half of the swivel part (300). Since the first opening (110) is configured for holding substantially half the swivel part (300) and the second opening (210) is configured for holding substantially the other half of the swivel part (300), the first part (100) and second part (200) are rotatably held together.

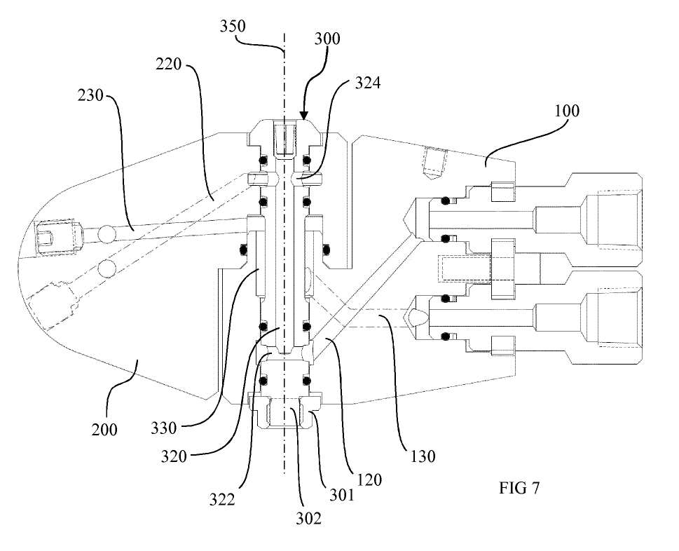

According to one embodiment, the coupling further comprises a swivel part second channel (330) for the return fluid. The swivel part second channel (330) may be formed around the swivel part (300) and inside one or both of the first part (100) and second part (200). The swivel part second channel (330) may thus be formed completely around, on the outside of, the swivel part (300) and inside one or both of the first part (100) and second part (200). In this way the swivel part channel (320) channels the supply fluid inside the swivel part (300) and the swivel part second channel (330) channels the return fluid outside the swivel part (300). This is shown in FIGS. 5 and 7. Naturally the supply and return fluids could be channelled vice versa.

According to one embodiment, the swivel part (300) comprises a first swivel part (301) and a second swivel part (302) connectable to each other. There may be, for example, a threaded engagement between the first swivel part (301) and the second swivel part (302) to connect the two. In this way the swivel part supports, holds, the first part (100) and the second part (200) together and allow them to rotate relatively. According to one embodiment shown in FIG. 5, the first swivel part (301) and the second swivel part (302) may have about the same length and be connectable to each other by a threaded engagement. According to one embodiment shown in FIG. 7, the first swivel part (301) may be like a nut and the second swivel part (302) may be stretching through the whole length of the first part (100) and the second part (200). The first swivel part (301) and the second swivel part (302) may be connectable to each other by a threaded engagement.

According to one embodiment, a rotation axis (250) of the second part (200) for the rotatable coupling (400) is substantially perpendicular to the rotation axis (350) of the swivel part (300). The rotation axis (250) of the rotatable coupling (400) goes through the second part (200) and allows the second part (200) to rotate via the rotatable coupling (400) around the rotation axis (250).

According to one embodiment, as shown in FIGS. 3-5, the coupling may further comprise one or more supports (170) for supporting the first part (100) and the second part (200) rotatably to each other. The one or more supports (170) may be on one or both sides of the swivel, connecting, for example a side of, the first part (100) with the swivel part (300) and/or connecting the second part (200) with the swivel part (300). Hereby the coaxial arrangement of the swivel is assisted. However, the support may not be necessary, especially if the bearings between the swivel part (300) and the first part (100) and the second part (200) are stiff enough.

According to one embodiment, as shown in FIGS. 5 and 7, the swivel part (300) comprises one or more first radial openings (322) in the swivel part (300) for the supply fluid to enter the swivel part first channel (320). The one or more first radial openings (322) being in fluid communication with the first part first channel (120) for the supply fluid. The swivel part (300) may further comprise one or more second radial openings (324) in the swivel part (300) for the supply fluid to exit the swivel part first channel (320). The one or more second radial openings (324) being in fluid communication with the second part first channel (220) for the supply fluid. In this way a fluid, supply or return fluid, may flow through the first part first channel (120), through the one or more first radial openings (322), through the swivel part first channel (320), through the one or more second radial openings (324), and through the second part first channel (220). This flow is shown by solid arrows in FIG. 5. Furthermore, a fluid, supply or return fluid, may flow through the second part second channel (230), through the swivel part second channel (330), and through the first part second channel (130). This flow is shown by hashed arrows in FIG. 5. The two flows are also present in FIG. 7, but not marked by arrows. This channelling of the fluid allows two fluids to be connected to the tool by the coupling.

According to one embodiment, the second part (200) is configured for removably receiving the rotatable coupling (400). The rotatable coupling (400) may be configured for delivering the supply fluid, for receiving the return fluid, and for direct or indirect coupling to a tool, preferably a hydraulic tool, such as a torque wrench tool. According to one embodiment, the coupling is a torque wrench coupling. Preferably the nipple for the rotatable coupling is arranged directly in the tool so that the coupling can be connected and the tool thereby received hydraulic power.

According to one embodiment, the coupling is for a high pressure supply fluid. The fluid, hydraulic fluid may be supplied with a pressure of 70 bar (7 MPa) or more, or 100 bar (10 MPa) or more, or 200 bar (20 MPa) or more, or 250 bar (25

MPa) or more, 300 bar (30 MPa) or more, 400 bar (40 MPa) or more, 500 bar (50 MPa) or more. The specific configuration of the coupling claimed balances the high pressure fluid flow through the coupling, allows for the coupling to swivel even under high pressure supply, allows for a compact coupling, reduces stress, and/or allows an easy and robust manufacturing. Additionally, the coupling allows for coupling parts to fit and work together with already existing tools, couplings, and hose kits. The parts of the coupling are not expensive to produce. The coupling avoids cumbersome arrangement or arrangements that are expensive to manufacture.

According to one embodiment, the coupling comprises an adapter for twin hoses or a coaxial hose for the supply and return fluids. The coaxial hose is not shown in the figures.

According to one embodiment, the coupling is configured for a supply fluid having a higher pressure than the return fluid. This configuration is made by channelling the supply fluid through the swivel part first channel (320). That is to say, the supply fluid is channelled through the first part first channel (120), through the one or more first radial openings (322), through the swivel part first channel (320), through the one or more second radial openings (324), and through the second part first channel (220). This specific configuration of the coupling claimed balances the high pressure fluid flow through the coupling. This provides a coupling with no leakages and a safe coupling.

According to one embodiment, a tool comprises a nipple and/or a coupling according to any one of the embodiments described above. Preferably, such a tool comprises that the rotatable coupling (400) of the coupling is connectable with the nipple, the nipple being directly arranged in the tool. The tool may be a hydraulic tool, such as a torque wrench tool.

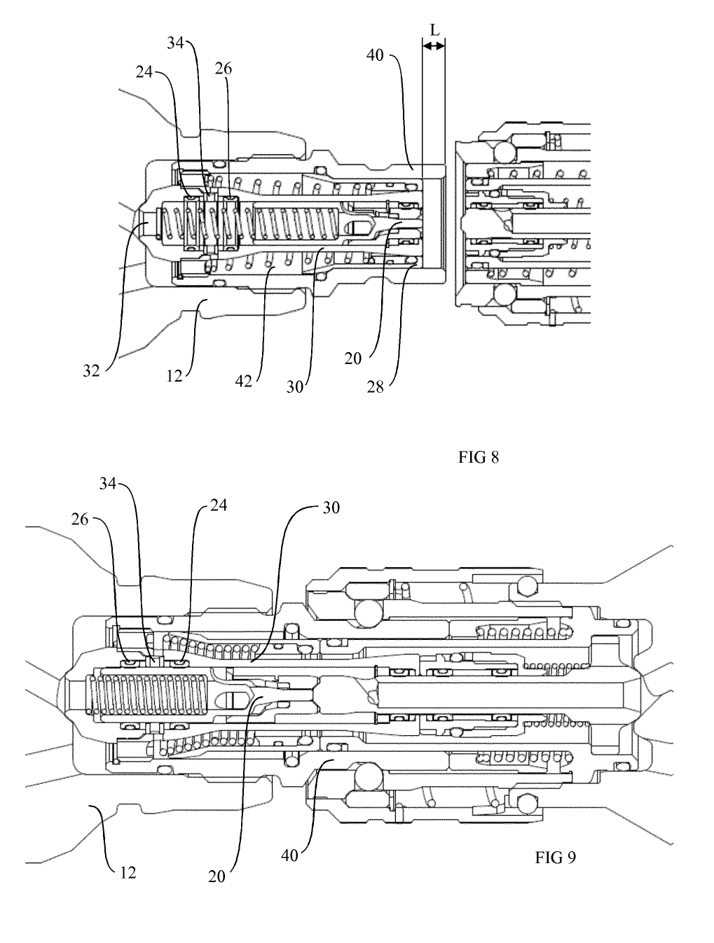

According to at least one embodiment, as shown in FIGS. 8 and 9, that can be combined with any suitable embodiment disclosed herein, the sealing means (24, 26) may be arranged on the nipple tube (30) for sealing against the valve (20). The sealing means (24, 26) may seal against a body of the valve (20), the body of the valve (20) being slideably arranged inside the nipple tube (30). Preferably the sealing means (24, 26) are arranged on each side of the relief passage (34); that is before and after the relief passage (34) in relation to the flow direction of the nipple when the coupling is fully engaged. In this way the sealing means (24, 26) are not always in contact with the body of the valve (20), and therefore less friction and less force may be used to move the valve (20) within the nipple tube (30).

In one embodiment, the sealing means (24, 26) may be, for example, a U-shaped Teflon ring with an o-ring inside the U of the U-shaped Teflon ring. A spacer may be used between the sealing means (24, 26) to position the sealing means (24, 26).

FIG. 8 illustrates the coupling not engages with the nipple. FIG. 9 illustrates when the coupling is fully engaged with the nipple, and then the body of the valve (20) is in the position illustrated in FIG. 9 where the valve (20), the body of the valve (20), engages the sealing means (24, 26). Hereby, the relief passage (34) is sealed and the dual flow of the co-axial coupling is established without flow through the relief passage (34).

A nipple is traditionally on a tool and a coupling on a tube that connects to the tool. The tool may for example be a rescue tool, such as a hydraulic pair of scissors, and the tube may be a coaxial tube for supplying hydraulic to the tool. The nipple and coupling may be a coaxial nipple and a coaxial coupling for the tool. In one embodiment, the features described herein of the nipple may be interchanged with the features of the coupling. That is, the housing (40) of the nipple may be a housing of the coupling, and the features, such as for example, the nipple tube (30), the valve (20), etc., may be part of the coupling instead of the nipple. In such an embodiment the traditional parts of the coupling are then in the nipple.

According to one embodiment, instead of having two sealing means (24, 26) arranged on the relief valve (20) or the nipple tube (30) that seals the relief passage (34), an alternative may be to have one sealing means (24) arranged on the body of the relief valve (20) and one sealing means (26) arranged on the nipple tube (30). These sealing means (24, 26) would then seal one on each side of the relief passage (34) when the nipple is fully engaged in the coupling, but they would not seal the relief passage (34) when the relief valve (20) is initially opened when the coaxial coupling is coupled. In this way a coupling can be made by hand force because all pressure built up can escape via the relief valve (20) using the relief passage (34), as shown in FIG. 8, and subsequent when the coupling is fully engaged, as shown in FIG. 9, then the relief passage (34) is sealed.

An embodiment as described with reference to FIGS. 8 and 9 and above has several technical advantages. For example, friction decreases between the bodies of the relief valve (20) and the nipple tube (30). This ensures in turn that a spring is always able to push the relief valve (20) into its forward closed position. A lower spring force is therefore required. This avoids unintended blocking of relief passage (34), which would otherwise increased the required connection force of the coupling, if not making it impossible to connect the coupling only by hand force. Additionally, there is no risk that residual pressure is trapped in between the sealing means (24, 26) as it could with the sealing means (24, 26) described above in relation to FIGS. 1 and 2. Such trapped pressure would further increase friction. Having only one sealing means (24) in the body of the relief valve (20), or the sealing means (24, 26) arranged on the nipple tube (30) allows for more space for a larger spring, e.g. increased spring diameter. Additionally, the free flow-diameter inside the nipple tube (30) increases and this causing less pressure drop for the coupling.

According to one embodiment, as shown in FIG. 8, that can be combined with any suitable embodiment disclosed herein, the housing (40) protrudes beyond the nipple tube (30) and valve (20), and is configured to seal with the coaxial coupling when the relief valve (20) is opened. The housing (40), the nipple's outer body, has a length (L) that is longer than at least the relief valve (20). The edge of the housing (40) protrudes over the edge of at least the relief valve (20), preferably over the edge of all the other nipple parts. As may be taken from FIG. 8 the housing (40) protrudes with a length (L) beyond the edges of the other nipple parts. This protrusion of the housing (40) achieves the technical effect of that the nipple, and the internal nipple parts, are already sealed against the outside environment when the coupling starts to open the pressure relief valve (20) inside the nipple to release residual pressure from the nipple and tool. This sealing may be improved by further sealing means, e.g. an o-ring, on the housing (40) or on the coupling. Depending on the residual pressure and amount of residual spill oil inside the nipple and/or tool a valve in the coupling may open if necessary leading the residual oil towards the couplings tank channel.

An embodiment with the protrusion of the housing (40) may have several technical advantages. One such advantage may be that pressurized residual spill oil from the nipple and/or tool is kept inside the coaxial coupling and can not escape to the environment. A further advantage is that pre pressurized residual oil can not harm an operator.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal languages of the claims.

### NIPPLE, LIST OF ELEMENTS

L protrusion of housing
10 nipple
12 tool
14 first opening
16 second opening
20 valve, relief valve
22 inner valve
24 sealing means
26 sealing means
28 outer valve
30 nipple tube
32 second passage
34 relief passage
40 housing
42 first passage
100 first part
110 first opening
120 first part first channel
130 first part second channel
170 one or more supports
200 second part
210 second opening
220 second part first channel
230 second part second channel
250 rotation axis of second part
300 swivel part
301 first swivel part
302 second swivel part
320 swivel part first channel
322 one or more first radial openings
324 one or more second radial openings
330 swivel part second channel
350 rotation axis of swivel part
400 rotatable coupling

1. A nipple for a coaxial coupling, the nipple comprising:
a housing;
a nipple tube arranged in the housing and a first passage between the housing and the nipple tube, the nipple tube comprising a second passage within the nipple tube;
a valve slideably arranged in the nipple tube;
sealing means for sealing between the nipple tube and the valve; and
wherein the nipple tube further comprises a relief passage, the relief passage forming a fluid passage between the first passage and the second passage, the relief passage being arranged so that the sealing means seals the relief passage when the nipple is fully coupled.

2. The nipple according to claim 1, wherein the valve is a relief valve.

3. The nipple according to claim 1, wherein the sealing means are arranged on the nipple tube.

4. The nipple according to claim 1, wherein at least one of:
the valve is spring loaded for movement away from the relief passage; and
the housing and the nipple tube both have a generally cylindrical form.

5. The nipple according to claim 1, wherein the nipple comprises an outer valve for the first passage.

6. The nipple according to claim 1, wherein the housing protrudes beyond the nipple tube and valve and is configured to seal with the coaxial coupling when the valve opened.

7. The nipple according to claim 1, wherein the nipple is attached directly in a hydraulic tool.

8. The nipple according to claim 1, wherein the nipple comprises a plurality of the relief passages between the first passage and the second passage, the plurality of relief passages being arranged so that the sealing means seals the plurality of relief passages when the nipple is fully coupled.

9. The nipple according to claim 1, wherein the nipple tube and the valve of the nipple is arranged in the coupling to the nipple.

10. A coupling comprising:
the nipple according to claim 1;
a swivel; and
wherein the swivel comprises:
a swivel part comprising a rotational axis;
a first part comprising a first opening for the swivel part;
a second part comprising a second opening for the swivel part, and the second part being configured for receiving a rotatable coupling for the nipple; and
the swivel part arranging the first part and the second part rotatably engaged with each other.

11. The coupling according to claim 10, wherein a rotation axis of the second part for the rotatable coupling is substantially perpendicular to the rotation axis of the swivel part.

12. The coupling according to claim 10, wherein the second part is configured for removably receiving the rotatable coupling and the rotatable coupling being configured for delivering the supply fluid, for receiving the return fluid, and for direct or indirect coupling to a tool.

13. The coupling according to claim 10, wherein the coupling is for a high pressure supply fluid.

14. The coupling according to claim 10, wherein the coupling comprises an adapter for twin hoses or a coaxial hose for the supply and return fluids.

15. (canceled)

16. The nipple according to claim 2, wherein the relief valve is the relief valve for an inner valve for the second passage.

17. The nipple according to claim 7, wherein the hydraulic tool is a torque wrench tool.
